(19) United States
(12) Patent Application Publication
(10) Pub. No.: US 2020/0074879 A1
(43) Pub. Date: Mar. 5, 2020

(54) SYSTEM AND METHOD FOR MODIFYING DIETARY RELATED BEHAVIOR

(71) Applicant: NUTRISTYLE INC., Meridian, ID (US)

(72) Inventors: Scott Murdoch, Bend, OR (US); Todd Albro, Eagle, ID (US); Caleb Skinner, Beaverton, OR (US); Shannon Madsen, Livermore, CA (US); Lee Brillhart, Seattle, WA (US)

(21) Appl. No.: 16/558,035

(22) Filed: Aug. 30, 2019

Related U.S. Application Data
(60) Provisional application No. 62/725,928, filed on Aug. 31, 2018.

(51) Int. Cl. G09B 19/00; G06N 20/00

(52) U.S. Cl. CPC G09B 19/00; G09B 19/0092; G06N 20/00

(57) ABSTRACT

A method of operating a system for modifying behavior involves generating behavior adherence data from monitored behavior data, meal planning data, meal consumption (or food log) data, and planned activities data through operation of a behavior analyzer. Behavior adherence data is stored as historical user behavior in a controlled memory data structure. A behavior modifying notification is generated from demographic information, the behavior adherence data, the historical user behavior, health and behavior research data, biometric data, and location data from a user's mobile device, through operation of a machine learning algorithm. The behavior modifying notification is displayed through a display device of the mobile device, and the displayed behavior modifying notification is communicated to the behavior analyzer for generating the behavior adherence data.

### BACKGROUND

Influencing individuals to make healthier dietary and related lifestyle decisions is a difficult task to accomplish and quantify. Many implementations of behavior modifying techniques that have been utilized in the past to help individuals make healthier decisions tend to be too broad and/or ineffective to appeal to individuals while lacking the resources to adequately gauge the effectiveness of the implementation. Therefore, a need exists for a system that encourages individuals to make healthier dietary decisions and influences those decisions.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system 100 in accordance with some embodiments.

FIG. 2 illustrates a method 200 for modifying behavior in accordance with some embodiments.

FIG. 3 illustrates a system 300 in accordance with some embodiments.

FIG. 4 illustrates a system 400 in accordance with some embodiments.

FIG. 5 illustrates a system 500 in accordance with some embodiments.

FIG. 6 illustrates a system 600 in accordance with some embodiments.

FIG. 7 illustrates a system 700 in accordance with some embodiments.

### DETAILED DESCRIPTION

“Smart Health Device” refers to a user worn, carried, or otherwise connected device that collects and stores data (and may provide additional analyses) on real-time physical activity, health status, and medical/clinical bio measurements. An example of a “smart health device” is a fitness tracker

“Food” refers to any substance consumed to provide nutritional support for an organism. For example, foods may be an assortment of consumable substances that include meats, grains, dairy products, fruits, mushrooms, vegetables, any plants, animals, insects, microbes, and any isolated or modified component of these. The foods may include condiments such as spices that may be added in combination to the aforementioned foods. Furthermore, foods may include beverages. Individual foods may be combined as components of a meal.

“Meal” refers to a single food component or combination of food components served individually or in combinations as a dish. A meal may include a dish of a variety of food components and spices accompanied by a beverage.

“Nutrient” refers to a substance used by an organism to survive, grow, and reproduce. The requirement for dietary nutrient intake applies to animals, plants, fungi, and protists. Nutrients can be incorporated into cells for metabolic purposes or excreted by cells to create non-cellular structures, such as hair, scales, feathers, or exoskeletons. Some nutrients can be metabolically converted to smaller molecules in the process of releasing energy, such as for carbohydrates, lipids, proteins, and fermentation products (ethanol or vinegar), leading to end-products of water and carbon dioxide. Nutrients include both macronutrients and micronutrients. Macronutrients provide energy and are chemical compounds that humans consume in the largest quantities and provide bulk energy are classified as carbohydrates, proteins, and fats. Water must be also consumed in large quantities. Micronutrients support metabolism and include dietary minerals and vitamins. Dietary minerals are generally trace elements, salts, or ions such as copper and iron. Some of these minerals are essential to human metabolism. Vitamins are organic compounds essential to the body. They usually act as coenzymes or cofactors for various proteins in the body. Nutrients also include bioactive compounds and nutraceuticals, which may be compounds found in foods, are not necessarily synthesized by the body, and are not directly involved in any fundamental functions of the body, yet can alter various metabolic functions within the body to impact health or disease. Some of these nutrients may include lipoic acid, ubiquinones (e.g., CoQ10, carotenoids, phenolic compounds, and the like). Other nutrients impact the functional characteristics of foods, which is defined by how the nutrients impact the consumer. For example, foods of this type include nutrients which impact the glycemic index/load which determines the impact of the food in causing increased blood glucose and/or insulin levels and acid/alkali forming which focuses on the impact on pH levels in the blood and cells, for example.

A system and method for modifying dietary related behavior provides users with personalized coaching to encourage a user to make healthier life choices based on their dietary and fitness related goals. The system utilizes a machine learning algorithm that incorporates behavioral studies from various research sources to create and modify contact with a user that is more likely to result in the desired change in their behavior. The system may provide the user with a behavior modifying notification following the detection of a target behavior or action by the user. The behavior modifying notification may encourage a user to continue performing the detected behavior or advise the user of the risk if they continue that behavior. The system may additionally incorporate information from a wearable or carried device such as a smart health device, to improve the accuracy of the behavior modifying notification. The system may also communicate with a meal plan generation system to identify a user's food preferences and dietary goals.

A method of operating a system for modifying behavior involves generating behavior adherence data from monitored behavior data, meal planning data, meal consumption (or food log) data, and planned activities data through operation of a behavior analyzer. Behavior adherence data is stored as historical user behavior in a controlled memory data structure. A behavior modifying notification is generated from demographic information, the behavior adherence data, the historical user behavior, health and behavior research data, biometric data, and location data from a user's mobile device, through operation of a machine learning algorithm. The behavior modifying notification is displayed through a display device of the mobile device, and the displayed behavior modifying notification is communicated to the behavior analyzer for generating the behavior adherence data.

The method of operating the system for modifying behavior may additionally include a smart health device to provide the biometric data to the machine learning algorithm. In the method of operating the system for modifying behavior, the monitored behavior data comprises physical activity data and user food log data.

In the method of operating the system for modifying behavior, the physical activity data may be provided by a smart health device. In the method of operating the system for modifying behavior, the meal planning data may be provided by a meal plan generation system. In the method of operating the system for modifying behavior, the meal planning data may comprise an intake targets and goals and a proposed meal plan.

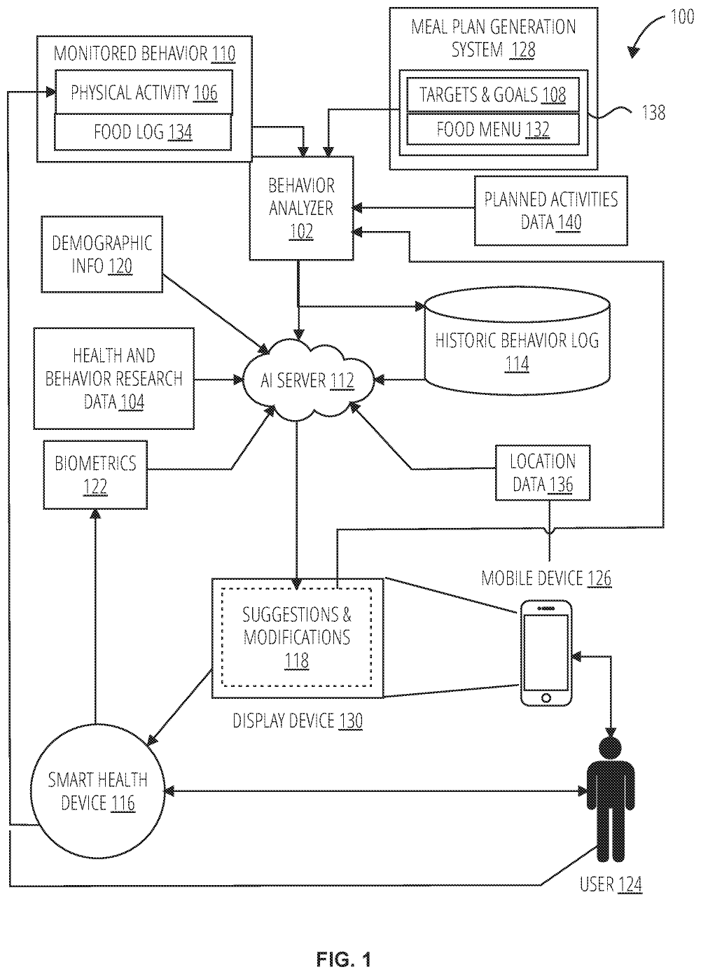

Referencing FIG. 1, a system 100 includes a meal plan generation system 128, a behavior analyzer 102, a machine learning algorithm 112 (AI server), a mobile device 126, and a smart health device 116. The behavior analyzer 102 collects monitored behavior data 110 comprising physical activity data 106 and a user food log data 134, meal planning data 138 comprising intake targets and goals 108 and proposed meal plan 132 (food menu), and planned activities data 140 and generates behavior adherence data. The meal planning data 138 may be provided by a meal plan generation system 128 utilized to assist a user in generating a meal plan for a future period of time. The behavior adherence data is stored as historical user behavior 114 in a controlled memory data structure and is provided to the machine learning algorithm 112 (AI server) for generating a behavior modifying notification 118 displayable in a display device 130. In some configurations, the behavior modifying notification 118 may include device configurations (e.g., trigger conditions) to deliver an alert to the user in response to a series of actions and events. For example, the smart health device 116 may function as a blood glucose and ketone monitor that detects when levels are at certain range defined by the machine learning algorithm, to notify the user through a vibration on their smart health device on through an alert displayable on the user device. The machine learning algorithm 112 may generate the behavior modifying notification 118 utilizing the behavior adherence data, demographic information 120, health and behavior research data 104, biometric data 122 from a smart health device 116, and location data 136 from the user's mobile device. The smart health device 116 may additionally provide physical activity data 106 utilized by the behavior analyzer 102. The planned activities data 140 may be collected from the user's day planner or social media activity made available to the system 100. The health and behavior research data 104 is provided to the machine learning algorithm 112 to enable the machine learning algorithm 112 to identify target behaviors that may be changed to improve the health of the user 124. The demographic information 120 may be utilized to determine similar users and predict the success of a possible suggestion and modification to change the behavior of the user.

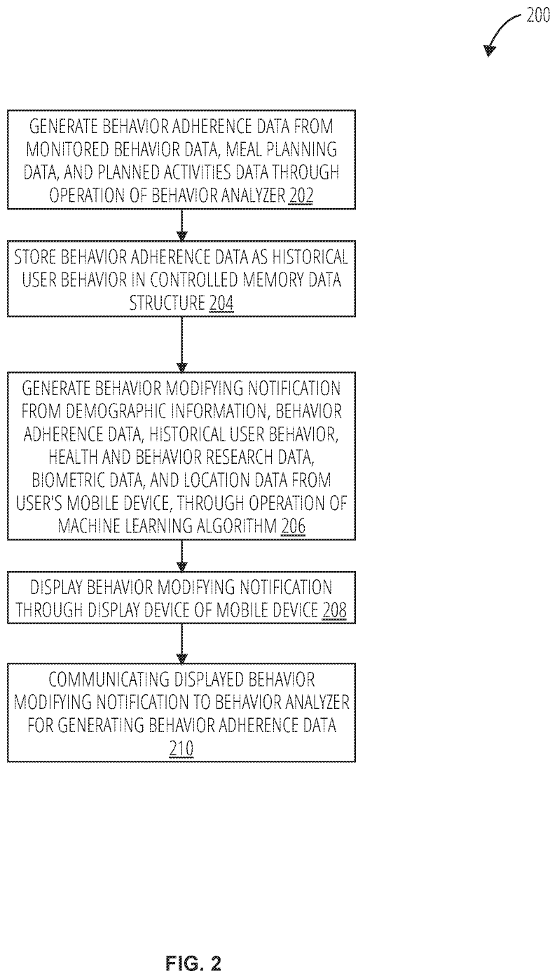

The system 100 may be operated in accordance with the process described in FIG. 2.

Referencing FIG. 2, a method 200 generates behavior adherence data from monitored behavior data (including user food log data), meal planning data, and planned activities data through operation of a behavior analyzer. In block 204, method 200 stores behavior adherence data as historical user behavior in a controlled memory data structure. In block 206, method 200 generates a behavior modifying notification from demographic information, the behavior adherence data, the historical user behavior, health and behavior research data, biometric data, and location data from a user's mobile device, through operation of a machine learning algorithm. In block 208, method 200 displays the behavior modifying notification (via various potential methods, including a standard pop-up, SMS, audio alarm, etc.) through a display device of the mobile device. In block 210, method 200 communicates displayed suggestions and modifications to the behavior analyzer for generating the behavior adherence data.

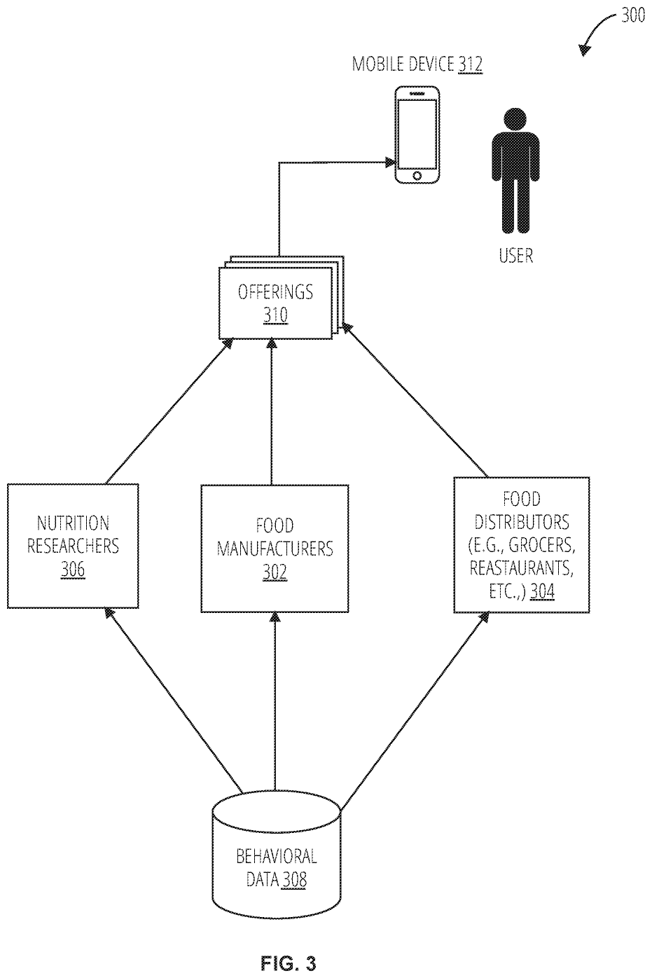

Referencing FIG. 3, a system 300 is shown in accordance with some embodiments. The system 300 illustrates behavioral data 308 being utilized by nutrition researchers 306, food manufacturers 302, and food distributors 304 to generate targeted offerings 310 that may be communicated to a user's mobile device 312. In some configurations, the food distributor 304 may be defined as any entity that is a source of food to grocers, other retailers, or directly to individuals in certain circumstances.

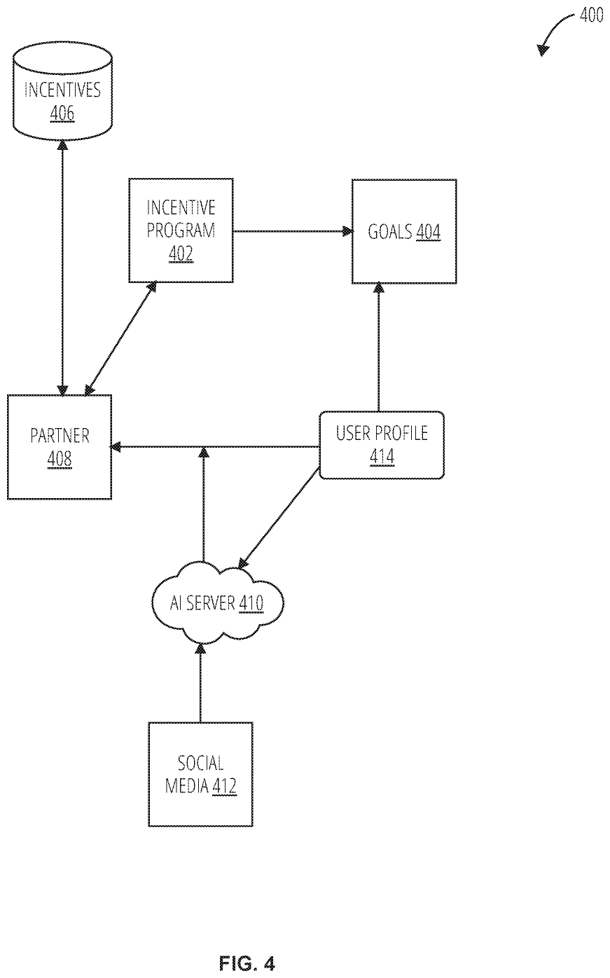

Referencing FIG. 4, a system 400 is shown in accordance with some embodiments. The system 400 illustrates a process of allowing a machine learning algorithm 410 to identify and communicate information associated with a specific user profile 414 to a plurality of advertising partners 408 based on the user's social media activity 412. The advertising partners 408 may be provided with associated information from the user profile 414 based on their currently running incentives 406. The incentives 406 may allow the advertising partners 408 to offer an incentive program 402 to a user profile 414 based on goals 404 and social media activity 412. In some configurations, the user profile 414 may include food preferences (i.e., likes/dislikes), food restrictions (e.g., gluten free), health objectives (e.g., lose weight), budget, preferred brands and/or private labels, and preferred grocers and/or food distributors that may be factored into the machine learning algorithm to generate a behavior modification notification.

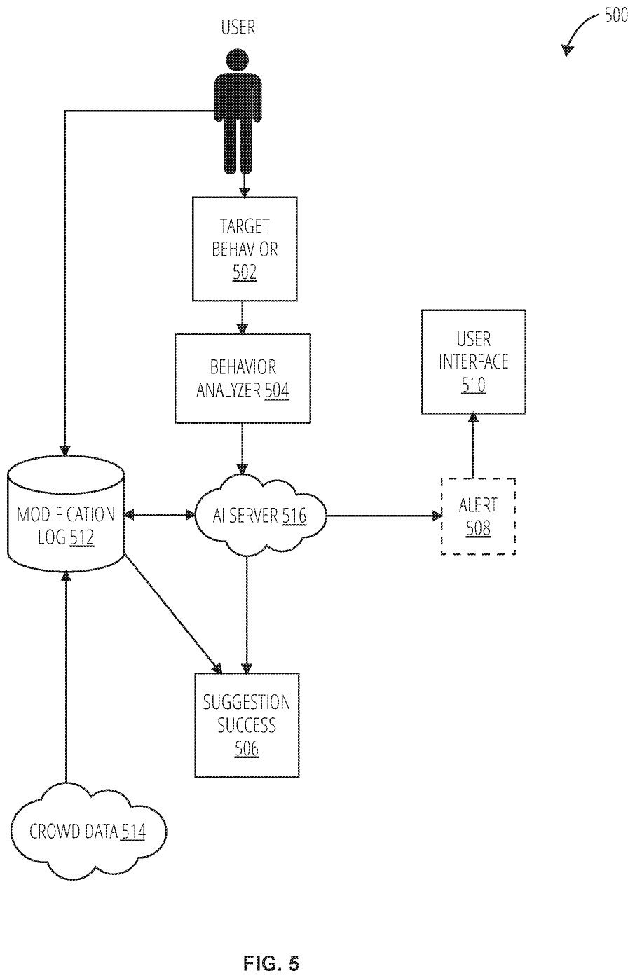

Referencing FIG. 5, a system 500 is shown in accordance with some embodiments. A behavior analyzer 504 of the system 500 may detect a target behavior 502 from the user. The behavior analyzer 504 communicates the detection of the target behavior 502 to the machine learning algorithm 516. The machine learning algorithm 516 may generate a behavior modifying notification 508 based in part on the suggestion success 506 of the behavior modifying notification 508. The suggestion success 506 may be determined by the machine learning algorithm 516 by referencing a modification log 512 comprising historical user behavior from the current user and similar users' behavior data 514 (crowd data). The behavior modifying notification 508 is then displayed through a user interface 510. In some configurations, the desired behavior change caused by the behavior modifying notification 508 may be stored in the modification log 512 to determine the suggestion success 506 of future alerts.

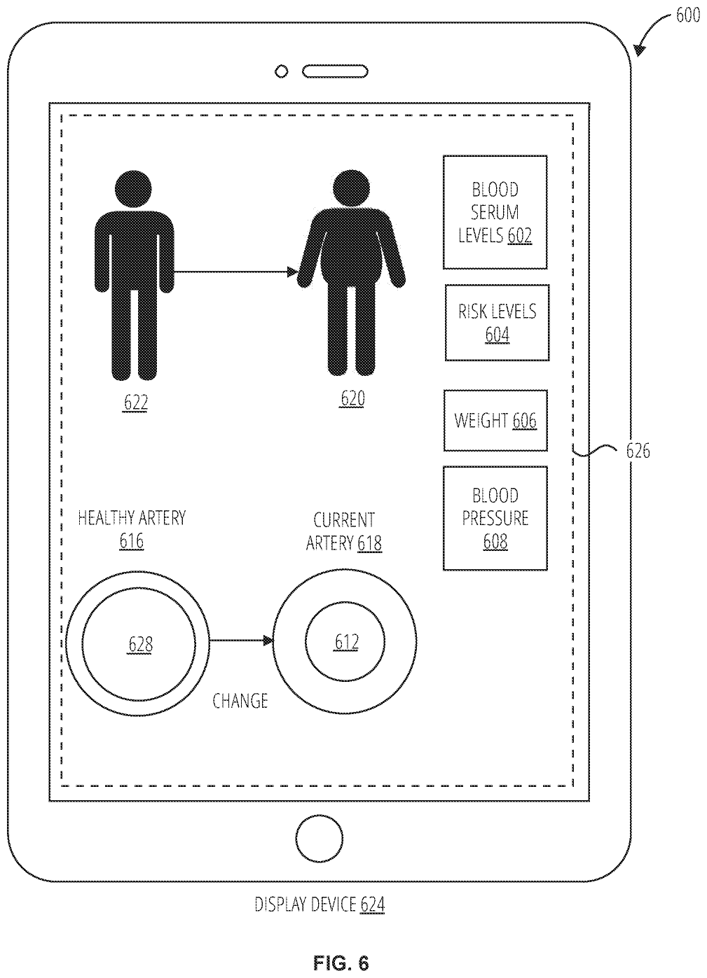

FIG. 6 illustrates a system 600 in accordance with some embodiments. The system 600 illustrates a display device 624 showing a behavior modifying notification 626 to suggest and modify a user's behavior. The behavior modifying notification 626 shows a representative healthy user avatar 622 compared to a current representation of the user's avatar 620. The behavior modifying notification 626 may show the current user's blood serum levels 602, risk levels 604, current weight 606, and blood pressure 608. The behavior modifying notification 626 may also show a comparison of a healthy artery 616 compared to the user's current artery 618. The comparison may also show how the change in diet affected the user by showing the simulated change between a healthy diameter 628 to the current diameter 612 of the user's arteries.

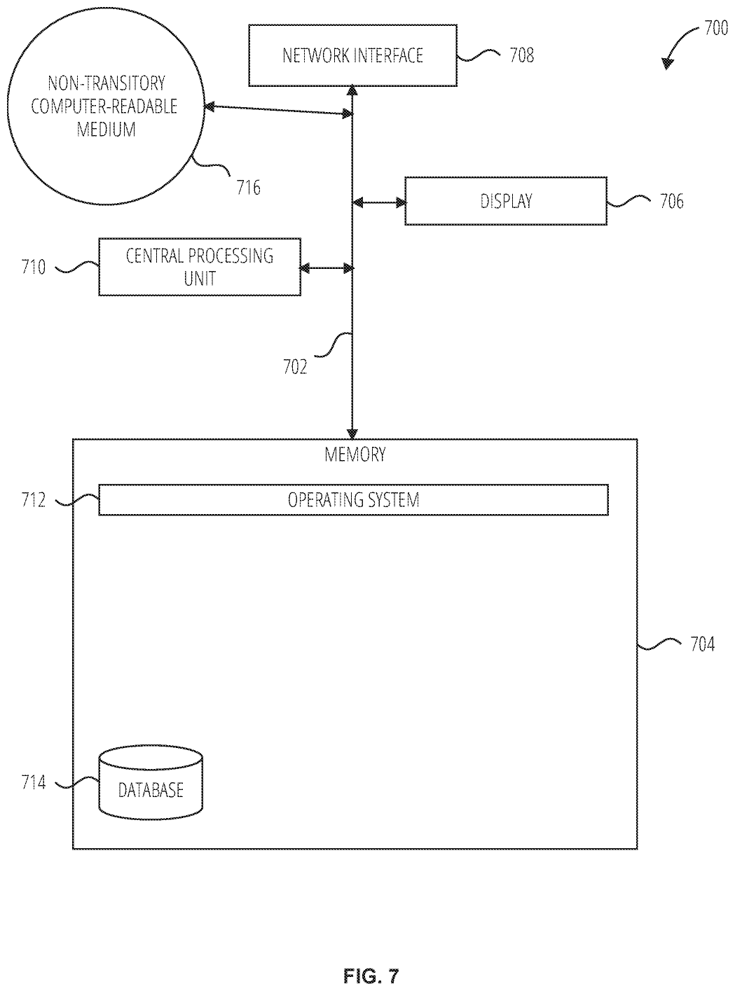

FIG. 7 illustrates several components of an exemplary system 700 in accordance with some embodiments. In various embodiments, system 700 may include a desktop PC, server, workstation, mobile phone, laptop, tablet, set-top box, appliance, or other computing device that is capable of performing operations such as those described herein. In some embodiments, system 700 may include many more components than those shown in FIG. 7. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 700 may comprise one or more physical and/or logical devices that collectively provide the functionalities described herein. In some embodiments, system 700 may comprise one or more replicated and/or distributed physical or logical devices.

In some embodiments, system 700 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 700 includes a bus 702 interconnecting several components including a network interface 708, a display 706, a central processing unit 710, and a memory 704.

Memory 704 generally comprises a random access memory (“RAM”) and permanent non-transitory mass storage device, such as a hard disk drive or solid-state drive. Memory 704 stores an operating system 712.

These and other software components may be loaded into memory 704 of system 700 using a drive mechanism (not shown) associated with a non-transitory computer-readable medium 716, such as a DVD/CD-ROM drive, memory card, network download, or the like.

Memory 704 also includes database 714. In some embodiments, system 700 may communicate with database 714 via network interface 708, a storage area network (“SAN”), a high-speed serial bus, and/or via the other suitable communication technology.

In some embodiments, database 714 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

Terms used herein should be accorded their ordinary meaning in the relevant arts, or the meaning indicated by their use in context, but if an express definition is provided, that meaning controls.

“Circuitry” refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” refers to software logic embodied as processor-executable instructions stored in read-only memories or media.

“Hardware” refers to logic embodied as analog or digital circuitry.

“Logic” refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

What is claimed is:

1. A method of operating a system for modifying behavior, the method comprising:
generating behavior adherence data from monitored behavior data, meal planning data, and planned activities data through operation of a behavior analyzer;
storing behavior adherence data as historical user behavior in a controlled memory data structure;
generating a behavior modifying notification from demographic information, the behavior adherence data, the historical user behavior, health and behavior research data, biometric data, and location data from a mobile device associated with a user, through operation of a machine learning algorithm;
displaying the behavior modifying notification through a display device of the mobile device; and
communicating displayed behavior modifying notification to the behavior analyzer for generating the behavior adherence data.

2. The method of claim 1, wherein a smart health device provides the biometric data to the machine learning algorithm.

3. The method of claim 1, wherein the monitored behavior data comprises physical activity data and user food log data.

4. The method of claim 3, wherein the physical activity data is provided by a smart health device.

5. The method of claim 1, wherein the meal planning data is provided by a meal plan generation system.

6. The method of claim 1, wherein the meal planning data comprises intake target goals and a proposed meal plan.

7. The method of claim 6, wherein the proposed meal plan is modified in response to the monitored behavior data.

8. The method of claim 1, further comprising determining, in response to the monitored behavior data, a physical activity target.

9. The method of claim 8, wherein determining the physical activity target comprises generating the physical activity targets through a machine learning algorithm.

10. The method of claim 9, further comprising displaying a notification of the physical activity target on the display.

11. The method of claim 10, further comprising determining a difference between the physical activity target and the monitored behavior data and providing a progress toward the physical activity target.

12. The method of claim 1, wherein the behavior modifying notification comprises a suggestion of an activity.

13. A method for tracking and modifying behavior, comprising:
monitoring a behavior of a user to generate historical behavior data;
determining meal planning data;
generating a behavior modifying notification based, at least in part, on the historical behavior data and the meal planning data;
displaying the behavior modifying notification on a display device of a mobile device associated with the user;
determining that the behavior of the user was modified by the behavior modifying notification data.

14. The method for tracking and modifying behavior as in claim 13, further comprising determining a physical activity target and comparing the behavior of the user to the physical activity target.

15. The method for tracking and modifying behavior as in claim 14, wherein the meal planning data comprises a food menu and the method further comprises modifying, in response to the behavior of the user being a threshold distance away from the physical activity target, the food menu.

16. The method for tracking and modifying behavior as in claim 13, further comprising receiving, from a smart health device, biometric data and generating the behavior modifying notification is based, at least in part, on the biometric data.

17. The method for tracking and modifying behavior as in claim 13, further comprising determining, for a behavior modifying notification, a suggestion success score, and providing the behavior modifying notification to another user based upon the suggestion success score.

18. A behavior modification system, comprising:
a behavior analyzer that receives monitored behavior data, meal planning data, and planned activities;
a controlled memory structure that stores historical user behavior data;
a smart health device that provides biometric data associated with a user to the behavior analyzer;
a machine learning algorithm that receives the historical user behavior data and the biometric data and is configured to generate behavior modifying notifications;
a display for displaying the behavior modifying notifications; and
an iterator that communicates displayed behavior modifying notifications and any resulting modified behavior to the behavior analyzer for generating behavior adherence data.

19. The behavior modification system of claim 18, further comprising a meal plan generation system that generates a meal plan based on one or more of nutritional targets, caloric intake targets, or the monitored behavior data.

20. The behavior modification system of claim 19, wherein the meal plan generation system is configured to modify based, at least in part, on the monitored behavior data deviating from the planned activities.
